(19) United States
(12) Patent Application Publication
(10) Pub. No.: US 2026/0041608 A1
(43) Pub. Date: Feb. 12, 2026

(54) SECONDARY PACKAGING FOR A MEDICINE PRODUCT AND METHOD FOR MANUFACTURING A MEDICINE PRODUCT

(71) Applicant: Fresenius Kabi Deutschland GmbH, Bad Homburg (DE)

(72) Inventors: Torsten BRANDENBURGER, Friedberg (DE); Beatrix HEUEL-HÖMMEN, Friedberg (DE)

(21) Appl. No.: 18/796,332

(22) Filed: Aug. 7, 2024

(51) Int. Cl. A61J 1/10; B32B 7/12; B32B 27/08; B32B 27/32; B32B 27/36; B65B 5/02; B65B 5/04; B65B 55/02; B65D 65/38; B65D 75/26; B65D 75/38; B65D 75/58

(52) U.S. Cl. CPC A61J 1/10; B32B 7/12; B32B 27/08; B32B 27/32; B32B 27/36; B65B 5/022; B65B 5/045; B65B 55/02; B65D 65/38; B65D 75/26; B65D 75/38; B65D 75/58; B32B 2255/10; B32B 2255/20; B32B 2307/7244; B32B 2307/7376; B32B 2439/46; B32B 2439/80; B65D 2565/387

(57) ABSTRACT

A film for a secondary packaging includes a first ply, a second ply, and a third ply. The first ply includes a polyolefin and the third ply includes a plastic. A first adhesive layer bonds the first ply and the second ply and a second adhesive layer bonds the second ply and the third ply. An oxygen barrier layer is between the first adhesive layer and the second adhesive layer. The oxygen barrier layer includes at least one of a metal oxide or a metalloid oxide. A primary packaging filled with a medical liquid can be arranged in the secondary packaging. A method for manufacturing a medicine product including the primary packaging arranged in the secondary packaging is also described.

The invention relates to secondary packaging, in the form of a bag, for primary packaging containing a medical liquid, for example a liquid for parenteral nutrition. The invention also relates to a medicine product having such secondary packaging.

The invention in particular relates to an infusion bag that is arranged in secondary packaging.

In particular, the invention relates to an infusion bag that is designed as a multi-component bag and is filled with the constituents of a preferably parenteral nutrition solution. This infusion bag is in particular designed for use in pediatrics.

The invention further relates to the use of an oxygen barrier layer for reducing the migration of cyclic diethylene glycol adipate.

### BACKGROUND OF THE INVENTION

Infusion bags designed as multi-chamber bags are used in particular for the provision of a parenteral nutrition solution. Such an infusion bag can in particular comprise three chambers containing a fat component, a protein component and a water (or salt-sugar solution) component. The components are mixed immediately before use. This is achieved in particular by opening peelable weld seams that separate the chambers of the bag from one another, by rolling and pressing the bag.

The infusion solution can then be removed via a connection set and administered to the patient. For this purpose, the primary packaging comprises at least one connector into which, for example, a spike or needle can be inserted. Such an infusion bag usually also comprises a further connector that serves as an injection port to add medication to the nutrition solution, for example using a needle syringe, if necessary.

The requirements for quality and sterility are high. It has therefore become established for such an infusion bag to be arranged in secondary packaging. During manufacture, the secondary packaging can be sterilized, in particular by autoclaving, together with the primary packaging already present in the closed secondary packaging. Thus, the entire primary packaging, including its outer surface, is sterile.

The secondary packaging is designed in particular as a welded film bag, which can be torn open to remove the primary packaging.

Some medical nutrition solutions are often very sensitive to oxygen. The same applies to infusion solutions containing an active ingredient that is sensitive to oxygen. It is therefore known that the secondary packaging has at least one oxygen barrier layer to reduce the migration of oxygen toward the primary packaging.

Such secondary packaging, in which a multi-chamber bag is arranged, is known, for example, from the published patent application WO 97/37628 A1.

The primary packaging can be formed from a multilayer polypropylene film. Multilayer polypropylene films are mechanically sufficiently stable and, in contrast to many other plastics, such as PVC, have improved properties, in particular with regard to avoiding migration of constituents from the film into the medical liquid or of constituents from the medical liquid into the film.

However, oxygen can migrate relatively easily through the film, which is why the secondary packaging for oxygen-sensitive products is provided with an oxygen barrier.

The secondary packaging can also be formed from a multilayer film. In contrast to the primary packaging, however, a polypropylene layer is used only as the innermost layer, whereas at least one outer layer is formed from PET, in the prior art described above. PET generally has a significantly lower elongation at break than polypropylene. A multilayer polypropylene film without other plastic layers would therefore be of little use as a tear-open bag.

The individual plastic plies of the film for the secondary packaging can be bonded to one another by means of an adhesive. For this purpose, there are machines that are suitable for coating long film webs with a defined amount of adhesive and bonding them on a large industrial scale.

It has been found in practice that, possibly due to the adhesive layer, undesirable substances, such as cyclic diethylene glycol adipate, can migrate from the secondary packaging into the primary packaging and then into the medical liquid contained therein.

This can result in a problem in particular for packaging with a small internal volume, such as that used in pediatrics, since the ratio of the surface area of the secondary packaging to the filling volume is quite high in this packaging.

### OBJECT OF THE INVENTION

The invention is therefore based on the object of reducing the aforementioned disadvantages of the prior art.

It is a particular object of the invention to provide secondary packaging or a medicine product having secondary packaging, in which the secondary packaging not only provides a good oxygen barrier, but also the migration of contained or forming constituents from the film of the secondary packaging toward the primary packaging is kept as low as possible.

### SUMMARY OF THE INVENTION

The object of the invention is already achieved by secondary packaging in the form of a bag, by a film designed for the secondary packaging, by the use of an oxygen barrier layer, and by a method for manufacturing a medicine product according to one of the independent claims.

According to a first aspect, the invention relates to secondary packaging in the form of a bag for a medicine product,
wherein the secondary packaging is formed from a film, which comprises an outer side and an inner side,
wherein the film comprises an oxygen barrier layer made of a metal oxide and/or metalloid oxide,
wherein the film comprises at least three plies, of which a first inner ply is a polyolefin, in particular a polypropylene, wherein a second ply and a third ply of a plastic adjoin in the direction of the outer side, wherein the three plies are bonded by means of a first adhesive layer and a second adhesive layer, and wherein the oxygen barrier layer is arranged between the first adhesive layer and the second adhesive layer.

Preferably, the film is formed or built up of exactly three plastic layers.

The positioning of the oxygen barrier layer between the inner polyolefin ply and the adjacent plastic layer means that there is only one adhesive layer toward the primary packaging that is inserted into the secondary packaging. This can further reduce the migration of undesirable substances that may form during storage toward the primary packaging.

Within the meaning of the invention, the inner polyolefin ply can also be provided consisting of a polyolefin-containing matrix phase polymer system. In a matrix phase polymer system, at least two different polymers are present, with one polymer being present in separated form, in particular as dispersed solidified droplets, in the matrix of the other polymer.

According to a preferred embodiment, the film for the secondary packaging comprises exactly one oxygen barrier layer and no further layers apart from the three plastic layers bonded via the adhesive layers. An absorber layer and/or a second oxygen barrier layer can be omitted, in particular when an inorganic metal oxide layer and/or metalloid oxide layer is used.

According to a preferred embodiment, the second ply comprises the oxygen barrier layer and is bonded to the first ply by means of the first adhesive layer, with the oxygen barrier layer adjacent to the first ply. The adhesive layer is therefore arranged between the first ply and the oxygen barrier layer.

By definition, the oxygen barrier layer is part of the second ply, i.e., part of the second plastic layer.

The second ply used can in particular be a plastic layer with a deposited inorganic oxide layer.

Such metal oxide layers or metalloid oxide layers are applied to the substrate in particular by means of physical or chemical vapor deposition. Even layers with a thickness of 0.5 to 10 μm form a good oxygen barrier. These are amorphous oxide layers, which can also be described as a glass layer or glassy layer.

The positioning of the oxygen barrier layer directly opposite the polyolefin ply means that the migration of any undesirable substances that may form in the second ply is also reduced.

The undesirable substances can in particular be an adipate, in particular a polyethylene glycol adipate, in particular a cyclic diethylene glycol adipate (cDEGA). The adipate can form in one of the plies, in particular in the first or second adhesive layer, in particular during storage.

The second ply and/or the third ply are preferably formed from a different plastic than the first ply.

An oxygen absorber can be arranged in the secondary packaging to further reduce the oxygen content in the packaging. This can be designed in particular as an inserted bag containing an oxygen-absorbing material, for example iron powder and sodium chloride.

In one embodiment of the invention, the oxygen barrier layer is formed from silicon oxide and/or aluminum oxide, in particular from amorphous silicon oxide and/or aluminum oxide. As stated above, the oxygen barrier layer can also be described as a glassy layer, in particular an inorganic glassy layer.

In one embodiment of the invention, the ratio of a thickness of the first ply to a thickness of the second ply including the oxygen barrier layer and/or to a thickness of the third ply is 2 to 20, preferably 3 to 15, particularly preferably 5 to 9.

The first ply is therefore preferably thicker than the second and/or third ply.

Furthermore, according to one exemplary embodiment, the first ply has a thickness of 50 to 200 μm, preferably of 75 to 95 μm.

The second ply, including the oxygen barrier layer, can have a thickness of 5 to 50 μm, preferably of 10 to 14 μm. The third ply can have a thickness of 5 to 50 μm, preferably of 10 to 14 μm.

Preferably, the secondary packaging is designed as a tear-open bag.

In one embodiment, the secondary packaging is formed from two films welded to one another. The secondary packaging thus has two longitudinal weld seams and two transverse weld seams.

To facilitate tearing, the secondary packaging can have at least one cut-out or notch. In one embodiment, the cut-out or notch extends into the region of a weld seam.

Primary packaging in the form of a bag, in particular an infusion bag, is preferably arranged in the secondary packaging.

According to one embodiment of the invention, the primary packaging is designed as an infusion bag and is constructed from a multilayer film welded together and has at least one weld seam, preferably at least one longitudinal weld seam and at least one transverse weld seam, at which two multilayer films are welded to one another. In particular, the primary packaging comprises two longitudinal weld seams and two transverse weld seams.

Furthermore, the primary packaging can comprise at least one port for removing a medical liquid. The port is also welded in, in particular with its lower part in the weld seam or one of the weld seams, in particular in a transverse weld seam. The lower part of the port can, for example, have a biconvex shape. The port can be part of a connector in which, in particular, a septum is arranged. For example, a needle, a spike or a Luer connector, in particular a Luer Lock connector, can be connected to the connector.

The primary packaging can also comprise a hanger for attachment to a rack or an infusion stand. The hanger can in particular be designed as a recess or cut-out in a transverse weld seam opposite the port.

According to one exemplary embodiment of the invention, the multilayer film of the primary packaging has at least three, preferably exactly three, plies. The plies are integrally bonded to one another. In particular, the plies are bonded to one another by co-extrusion and subsequent joining in the hot state. At least one ply of the multilayer film can be formed from a matrix phase polymer system.

The inner ply is in contact with the medical liquid. The outer ply covers at least some portions of the surface of the medical packaging designed as an infusion bag.

In a matrix phase polymer system, as described above, at least two different polymers are present, with one polymer being present in separated form, in particular as dispersed solidified droplets, in the matrix of the other polymer.

The matrix polymer of the matrix phase polymer system of the inner ply, the middle ply and the outer ply each comprises a polypropylene polymer. In particular, the matrix consists of a polypropylene.

The phase polymer of the matrix phase polymer system of the inner ply, the middle ply and the outer ply can each comprise at least one styrene-ethylene/butylene-styrene block copolymer (SEBS) as the phase polymer.

SEBS is a block polymer that is composed of styrene, butylene and ethylene portions and comprises a hydrogenated butadiene portion to which styrene groups are adjoined. This is produced in particular by polymerization of a styrene and butadiene monomer and subsequent hydrogenation of the previously polymerized SBS. The hydrogenated butadiene forms a soft middle block between the styrene blocks. The SEBS forms a good bond with the PP matrix polymer.

In this way, a mechanically stable primary packaging can be provided, which can be used in particular as an infusion bag for a nutrition solution, preferably a parenteral nutrition solution.

The primary packaging can in particular be designed as a multi-chamber bag. The components of a nutrition solution for parenteral nutrition can be arranged in the multi-chamber bag.

The chambers are preferably separated from one another by peelable weld seams.

For example, by rolling the primary packaging, these weld seams are separated and the components that form the nutrition solution mix with one another.

Preferably, the primary packaging comprises at least two ports, one of which serves as an injection port, in particular for a medication.

The secondary packaging is preferably sterilized, in particular by autoclaving, together with the primary packaging arranged in the secondary packaging.

Furthermore, both the secondary packaging and the primary packaging are preferably transparent.

According to a further aspect, the invention relates to a medicine product that comprises the above secondary packaging and primary packaging arranged in the secondary packaging.

As described above, the primary packaging is in particular in the form of a bag.

According to one embodiment, the primary packaging for a single-chamber bag is filled with a medical liquid with a total volume of 10 to 120 ml. According to a further embodiment, the primary packaging for a multi-chamber bag is filled with a medical liquid with a total volume of 150 to 2000 ml. In particular for pediatric applications, the primary packaging for a multi-chamber bag is filled with a medical liquid with a total volume of 150 to 500 ml. The total volume is the sum of the individual chamber volumes in a multi-chamber bag.

The medical liquid is a liquid that is used for medical purposes and is administered intravenously. In a preferred embodiment, the medical liquid is an infusion solution. In particular, the medical liquid is an oxygen-sensitive medical liquid.

Possible examples of such infusion solutions include
solutions, emulsions and/or suspensions containing nutrients for parenteral nutrition, in particular containing lipids, amino acids and/or glucose;
colloid solutions, in particular for blood replacement therapy (e.g. Voluven®); and/or
so-called premixed systems, in which an active ingredient has already been added to the medical liquid, e.g. paracetamol or propofol.

In particular, the primary packaging contains the components of a nutrition solution for use in pediatrics. In particular, the primary packaging can contain the components of a nutrition solution for premature babies of very low birth weight (VLBW) of less than 1500 g or for premature babies of extremely low birth weight (ELBW) of less than 1000 g.

The invention further relates to a film that is designed for the secondary packaging described above.

The film can in particular be designed as described above in connection with the design of the film from which the secondary packaging is formed.

It is therefore in particular a film with three plastic plies, of which a first ply is formed from a polypropylene, and wherein an oxygen barrier layer is located between a first adhesive layer and a second adhesive layer.

According to a further aspect, the invention relates to the use of an oxygen barrier layer for reducing the migration of cyclic diethylene glycol adipate from secondary packaging formed from a multilayer plastic film with at least one adhesive layer, toward a medical liquid contained in primary packaging inserted into the secondary packaging.

As described above, an inorganic metal oxide layer and/or metalloid oxide layer can reduce the migration of cyclic diethylene glycol adipate, which may form in the film, in particular in the adhesive layers, during storage.

According to a preferred embodiment, the oxygen barrier layer is arranged between a first adhesive layer and a second adhesive layer.

The adhesive is preferably a polyurethane-based two-component adhesive.

According to a further aspect, the invention relates to a method for manufacturing a medicine product, in particular a medicine product as described above, comprising the steps:
providing a polyolefin film as the first ply,
providing a polyethylene terephthalate film having an oxygen barrier layer as the second ply,
providing a polyethylene terephthalate film as the third ply,
bonding the first, second and third plies by means of an adhesive so that a multilayer plastic film is formed,
providing primary packaging in the form of a bag containing a medical liquid,
inserting the primary packaging in the form of a bag between two of the multilayer plastic films,
producing secondary packaging by welding the multilayer plastic films,
sterilizing, in particular autoclaving, the secondary packaging with the primary packaging arranged in the secondary packaging.

The oxygen barrier layer is preferably arranged such that it is adjacent to the first ply.

A polyurethane-based two-component adhesive is preferably used to bond the films.

### BRIEF DESCRIPTION OF THE DRAWINGS

The subject matter of the invention will be explained in more detail below with reference to a schematically illustrated exemplary embodiment using the drawings FIG. 1 to FIG. 3.

FIG. 1 shows medical packaging in the form of an infusion bag.

FIG. 2 is a schematic sectional view of the multilayer film used for the infusion bag.

FIG. 3 is a flow chart of an exemplary embodiment of the method according to the invention.

### DETAILED DESCRIPTION

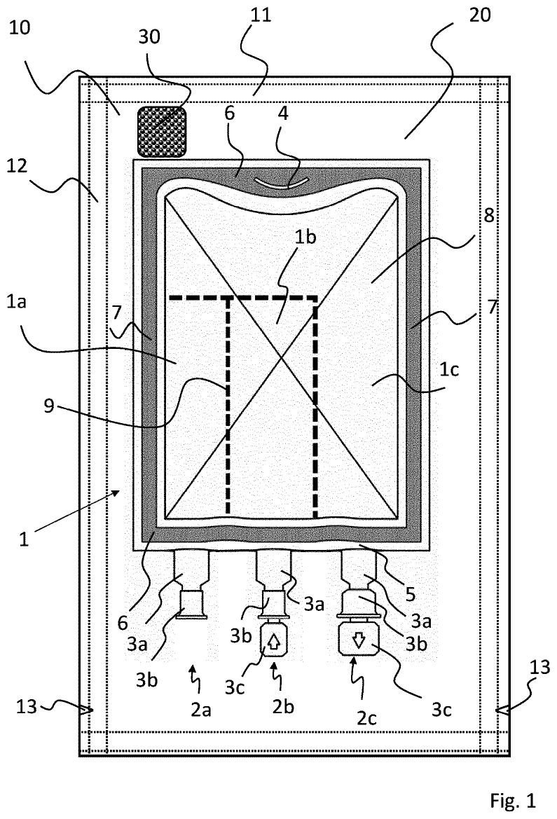

FIG. 1 shows medical primary packaging in the form of an infusion bag 1, which is arranged in secondary packaging 10 in the form of a tear-open bag.

The infusion bag 1 consists of two multilayer films 8 welded to one another. The multilayer films 8 are bonded to one another via the longitudinal weld seams 7 and the transverse weld seams 6, so that a bag is formed, which is filled with a medical liquid.

The multilayer films 8 are bonded to one another in particular by means of an impulse welding method. In this case, the films 8 are welded by means of a welding tool with heatable sealing strips that come into contact with the film, by temporarily heating the sealing strips so that the films clamped between the sealing strips become molten at least in some portions and are thus welded.

The infusion bag 1 comprises at least one port, in this exemplary embodiment three ports 2a, 2b, 2c, of which one port 2b is used for adding liquid, for example for dosed addition of a medication, and another port 2c is used for removing the medical liquid.

In this exemplary embodiment, the ports 2a-c comprise a biconvex welding-in portion 3a, with which they are welded in a region 5 of a transverse weld seam 6.

In this exemplary embodiment, the port 2a is designed as a blind port, which is only closed with the upper part 3b.

The two ports 2b and 2c each provide the lower part 3a of a connector. The two connectors are each formed by the two lower parts 3a and the upper parts 3c. Preferably, the upper part 3b is placed on the lower part 3a, in particular by being pressed on. A septum (not shown in the figures here), which closes the passage in the port 2b, 2c or in the connector to the bag volume, is enclosed form-fittingly between each lower part 3a and the upper part 3b. The said septum is a self-closing, resealable elastomer element, which can be pierced with a spike and/or a needle in order to remove or add liquid. After the spike and/or needle are pulled out, the septum closes automatically. Polyisoprene, for example, can be used as the elastomer material. Furthermore, the upper part 3b of the connector in each case comprises a break-off cap 3c, which covers the septum. Each septum is therefore only accessible after breaking off cap 3c.

Furthermore, the infusion bag 1 comprises, on the side opposite the at least one port 2b, 2c, a hanger 4 for attaching the infusion bag to an infusion stand or a rack. The hanger 4 can be designed as a cut-out or punched-out portion in the transverse weld seam 6.

The infusion bag 1 is designed here as a multi-chamber bag, with, for example, three chambers 1a-1c.

In particular, the components of a parenteral nutrition solution can be arranged in the chambers 1a-1c. These can be divided in particular into a protein component, a fat component and a water component. In particular, the infusion bag 1 contains a parenteral nutrition solution for pediatrics.

The chambers 1a-1c are separated from one another by detachable weld seams 9.

In this exemplary embodiment, the three ports 2a, 2b and 2c can be used in the manufacture of the infusion bag 1 to add one component of the nutrition solution into each of the individual chambers 1a-1c.

The port 2a is designed as a blind port and, unlike the ports 2b and 2c, has no function after the infusion bag has been filled. The infusion bag 1 is otherwise formed from a multilayer polypropylene film.

In order to ensure that the infusion bag 1 is completely sterile, i.e., also on its outside, it is arranged in secondary packaging 10 and is sterilized together with the secondary packaging 10.

The secondary packaging 10 is designed as a tear-open film bag.

For this purpose, two opposing films 20 are bonded to one another by means of a transverse weld seam 11 and a longitudinal weld seam 12. The secondary packaging 10 is provided with an oxygen barrier layer 25. Furthermore, an oxygen absorber 30 is located in the secondary packaging 10.

In order to be able to easily tear open the secondary packaging 10 designed as a film bag, it comprises at least one cut-out on the edge, in particular in the form of a notch 13, which can extend into the weld seam 12. Starting from the notch 13, the beginning of a tear line is provided when tearing. The secondary packaging 10 can thus be easily torn open and the primary packaging in the form of the infusion bag 1 can be removed.

In contrast to the film 8 of the infusion bag 1, the secondary packaging 10 comprises a multilayer film 20 which, in addition to an inner first polypropylene ply 23, has a second and a third ply 26, 28 made of a different plastic with a lower elongation at break than the first ply 23.

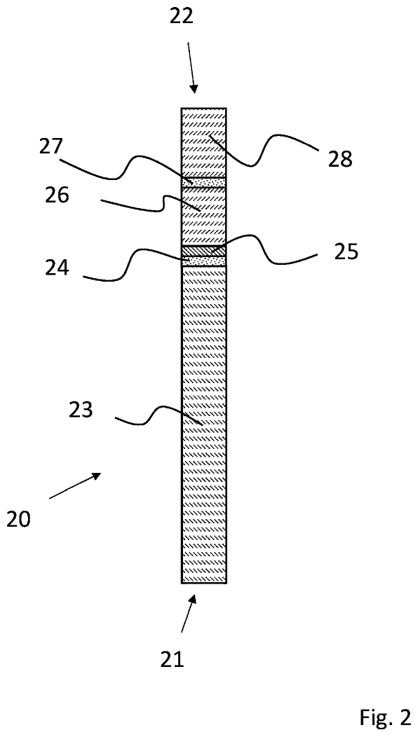

FIG. 2 is a schematic cross-section showing the structure of the film 20 from its inner side 21 to the outer side 22.

The first ply 23 is provided by a polypropylene film, in particular with a thickness of 75 to 95 μm. The first ply 23 is bonded to a second ply 26 via an adhesive layer 24, preferably with a weight per unit area of 2 to 5 g/m².

The second ply 26, including an oxygen barrier layer 25, has a thickness of 10 to 14 μm. The oxygen barrier layer 25 is present as a deposited silicon oxide layer or aluminum oxide layer on the second ply 26. Thus, the oxygen barrier layer is directly bonded to the first ply 23 via the first adhesive layer 24. This reduces the migration not only of oxygen, but in particular also of cyclic diethylene glycol adipate toward the first ply 23 and thus toward the primary packaging 1.

The second ply 26 is bonded to the third ply 28 via a second adhesive layer 27. The third ply 28 preferably has a thickness of 10 to 14 μm. The second adhesive layer 27 preferably has a weight per unit area of 2 to 5 g/m².

The first and second adhesive layers 24, 27 are preferably formed by a polyurethane-based two-component adhesive.

The second ply 26 and the third ply 28 are preferably formed from a polyethylene terephthalate (PET). These layers help to make the secondary packaging 10 easy to tear, among other things.

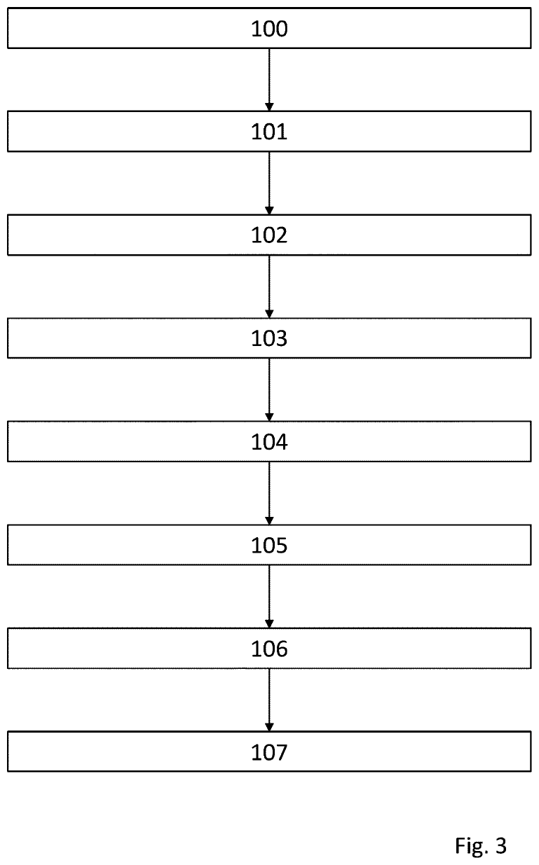

FIG. 3 is a flow chart of the method steps according to an exemplary embodiment of the invention.

First, a polyolefin film is provided as the first ply 100.

A polyethylene terephthalate film having an oxygen barrier layer is provided as the second ply 101.

This is followed by providing a polyethylene terephthalate film as the third ply 102, bonding the first, second and third plies by means of an adhesive, wherein the second ply is arranged such that the oxygen barrier layer is adjacent to the first ply, so that a multilayer plastic film is formed 103.

Primary packaging in the form of a bag containing a medical liquid is then provided 104.

The primary packaging in the form of a bag is inserted between two of the multilayer plastic films 105.

The secondary packaging is then produced by welding the multilayer plastic films 106.

This is followed by sterilization, in particular autoclaving, of the secondary packaging with the primary packaging arranged in the secondary packaging 107.

### LIST OF REFERENCE SIGNS

1 Primary packaging/infusion bag
1a-c Chamber
2a Blind port
2b Port (for addition)
2c Port (for removal)
3a Lower part
3b Upper part
3c Cap/break-off part
4 Hanger
5 Region of biconvex welding-in portion
6 Transverse weld seam
7 Longitudinal weld seam
8 Film
9 Weld seams of chambers
10 Secondary packaging
11 Transverse weld seam
12 Longitudinal weld seam
13 Notch
20 Film
21 Inner side
22 Outer side
23 1st ply
24 1st adhesive layer
25 Oxygen barrier layer
26 2nd ply
27 2nd adhesive layer
28 3rd ply
30 Oxygen absorber
100 Providing a polyolefin film as the first ply
101 Providing a polyethylene terephthalate film having an oxygen barrier layer as the second ply
102 Providing a polyethylene terephthalate film as the third ply
103 Bonding the first, second and third plies by means of an adhesive, wherein the second ply is arranged such that the oxygen barrier layer is adjacent to the first ply, so that a multilayer plastic film is formed
104 Providing primary packaging in the form of a bag containing a medical liquid
105 Inserting the primary packaging in the form of a bag between two of the multilayer plastic films
106 Producing secondary packaging by welding the multilayer plastic films,
107 Sterilizing, in particular autoclaving, the secondary packaging with the primary packaging arranged in the secondary packaging.

1. A secondary packaging for a medicine product, the secondary packaging formed of a film, the film comprising:
a first ply comprising a polyolefin;
a second ply;
a third ply comprising a plastic;
a first adhesive layer bonding the first ply and the second ply;
a second adhesive layer bonding the second ply and the third ply; and
an oxygen barrier layer between the first adhesive layer and the second adhesive layer, wherein the oxygen barrier layer comprises at least one of a metal oxide or a metalloid oxide.

2. The secondary packaging of claim 1, wherein the second ply comprises the oxygen barrier layer, and the oxygen barrier layer is adjacent to the first ply.

3. The secondary packaging of claim 1, wherein the polyolefin is a polypropylene.

4. The secondary packaging of claim 1, wherein the first adhesive layer or the second adhesive layer comprises an adipate.

5. The secondary packaging of claim 4, wherein the adipate is a polyethylene glycol adipate.

6. The secondary packaging of claim 5, wherein the polyethylene glycol adipate is a cyclic diethylene glycol adipate.

7. The secondary packaging of claim 6, wherein the oxygen barrier layer is configured to reduce migration of the cyclic diethylene glycol adipate from the second adhesive layer toward a primary packaging inserted into the secondary packaging.

8. The secondary packaging of claim 1, wherein the second ply comprises a polyethylene terephthalate.

9. The secondary packaging of claim 1, wherein the metal oxide or the metalloid oxide is a silicon oxide or an aluminum oxide.

10. The secondary packaging of claim 1, wherein a ratio of a thickness of the first ply to the second ply or to the third ply is from 2 to 20.

11. The secondary packaging of claim 1, wherein:
the first ply has a thickness of from 50 to 200 μm,
the second ply has a thickness of from 5 to 50 μm, or
the third ply has a thickness of 5 to 50 μm.

12. The secondary packaging of claim 1, wherein:
the secondary packaging is formed as a tear-open bag,
a primary packaging is arranged in the secondary packaging, and.
an oxygen absorber is arranged in the secondary packaging.

13. A medicine product comprising:
the secondary packaging of claim 1; and
a primary packaging arranged in the secondary packaging, wherein the primary packaging is filled with a medical liquid.

14. The medicine product of claim 13, wherein the primary packaging is formed from a multilayer polypropylene film.

15. The medicine product of claim 14, wherein the multilayer polypropylene film comprises at least one ply comprising a matrix phase polymer system.

16. The medicine product of claim 13, wherein the primary packaging in the form of:
a single-chamber bag filled with a volume of from 10 to 120 ml of the medical liquid, or
a multi-chamber bag filled with a total volume of from 150 to 2000 ml of the medical liquid.

17. The medicine product of claim 13, wherein the medicine product is sterilized.

18. A film for a secondary packaging, the film comprising:
a first ply comprising a polyolefin;
a second ply;
a third ply comprising a plastic;
a first adhesive layer bonding the first ply and the second ply;
a second adhesive layer bonding the second ply and the third ply; and
an oxygen barrier layer between the first adhesive layer and the second adhesive layer, wherein the oxygen barrier layer comprises at least one of a metal oxide or a metalloid oxide.

19. A method for manufacturing a medicine product, the method comprising:
providing a polyolefin film as a first ply;
providing a polyethylene terephthalate film having an oxygen barrier layer as a second ply;
providing a polyethylene terephthalate film as a third ply;
bonding the first ply, the second ply, and the third ply using an adhesive to form a multilayer plastic film;
providing a primary packaging filled with a medical liquid;
inserting the primary packaging between two of the multilayer plastic films;
producing secondary packaging by welding the two multilayer plastic films around the primary packaging; and
sterilizing the secondary packaging with the primary packaging arranged in the secondary packaging.

20. The method of claim 19, wherein the adhesive is a polyurethane-based two-component adhesive.
